(19) United States
(12) Patent Application Publication
(10) Pub. No.: US 2019/0308622 A1
(43) Pub. Date: Oct. 10, 2019

(54) VEHICLE TRAVEL CONTROL SYSTEM

(71) Applicant: TOYOTA JIDOSHA KABUSHIKI KAISHA, Toyota-shi (JP)

(72) Inventors: Wataru Minoura, Susono-shi (JP); Kiyohiro Sogen, Sunto-gun (JP); Yuichiro Nara, Yokohama-shi (JP); Shuichi Morimoto, Susono-shi (JP)

(73) Assignee: TOYOTA JIDOSHA KABUSHIKI KAISHA, Toyota-shi (JP)

(21) Appl. No.: 16/274,670

(22) Filed: Feb. 13, 2019

(30) Foreign Application Priority Data
Apr. 9, 2018 (JP) 2018-074645

(51) Int. Cl. B60W 30/12; G06K 9/00; G08G 1/16

(52) U.S. Cl. CPC B60W 30/12; B60W 2550/22; G08G 1/167; G06K 9/00798

(57) ABSTRACT

A vehicle travel control system installed on a vehicle executes vehicle travel control that determines a travel lane and controls the vehicle to travel in the travel lane based on driving environment information. A restricted lane section is a lane and a section of lane in which a specific type of vehicle is prohibited from traveling. An avoidance target lane section is the restricted lane section in which the vehicle is prohibited from traveling. The driving environment information includes: vehicle type information indicating a type of the vehicle; and restricted lane section information indicating a position of the restricted lane section. The vehicle travel control system recognizes the avoidance target lane section based on the vehicle type information and the restricted lane section information, and executes the vehicle travel control so as to avoid the avoidance target lane section.

### BACKGROUND

### Technical Field

The present disclosure relates to a vehicle travel control system installed on a vehicle.

### Background Art

Patent Literature 1 discloses an in-vehicle navigation device that searches for a navigation route. When installing the navigation device on a vehicle, a user input a type of the vehicle. When searching for the navigation route, the navigation device considers the type of the vehicle and excludes a road through which the vehicle cannot pass. For example, in a case where the vehicle is a large-sized vehicle, the navigation device searches for the navigation route with excluding narrow roads.

Patent Literature 2 discloses a restricted lane detection device that detects a restricted lane in which lane restriction is performed. The restricted lane detection device collects travel information from vehicles that are traveling or have traveled in a zone where the lane restriction is performed. Then, the restricted lane detection device detects a lane in which no vehicle travels in the zone, as the restricted lane.

### LIST OF RELATED ART

Patent Literature 1: Japanese Unexamined Patent Application Publication No. JP-H11-002535
Patent Literature 2: Japanese Unexamined Patent Application Publication No. 2006-236247

### SUMMARY

Let us consider “vehicle travel control” that controls travel of a vehicle. It is desired in the vehicle travel control to make the vehicle travel appropriately in consideration of traffic regulations and the like. In this regard, the inventors of the present application have noticed that there is a lane in which a specific type of vehicle is prohibited from traveling. For example, there is a case where a large-sized vehicle is prohibited from traveling in a rightmost lane of a three-lane road. If the vehicle travel control is simply executed in such a situation, the specific type of vehicle may enter the lane in which it is prohibited from traveling. This causes decrease in confidence in the vehicle travel control.

According to the technique disclosed in the above-mentioned Patent Literature 1, the navigation device searches for the navigation route with excluding a road through which the vehicle cannot pass. For example, in a case where the vehicle is a large-sized vehicle, the navigation device searches for the navigation route with excluding narrow roads. However, information of lanes is not considered in the technique. Therefore, the specific type of vehicle following the navigation route may enter the lane in which it is prohibited from traveling.

A first aspect is directed to a vehicle travel control system installed on a vehicle.

The vehicle travel control system includes:

an information acquisition device configured to acquire driving environment information indicating driving environment for the vehicle; and

a vehicle travel control device configured to execute vehicle travel control that determines a travel lane and controls the vehicle to travel in the travel lane based on the driving environment information.

A restricted lane section is a lane and a section of lane in which a specific type of vehicle is prohibited from traveling.

The driving environment information includes:

lane configuration information indicating a configuration of each lane;

position information indicating a position of the vehicle with an accuracy with which the travel lane is identifiable;

vehicle type information indicating a type of the vehicle; and

restricted lane section information indicating a position of the restricted lane section.

The vehicle travel control device is further configured to:

recognize, based on the vehicle type information and the restricted lane section information, an avoidance target lane section being the restricted lane section in which the vehicle is prohibited from traveling; and

execute the vehicle travel control so as to avoid the avoidance target lane section based on the lane configuration information and the position information.

A second aspect has the following feature in addition to the first aspect.

The restricted lane section information includes at least one of:

lane attribute information indicating a position of the restricted lane section that steadily exists; and

temporal restriction information indicating a position of the restricted lane section that temporarily occurs.

A third aspect has the following feature in addition to the second aspect.

The vehicle travel control system further includes an information providing device configured to communicate with a surrounding vehicle.

When the restricted lane section information includes the temporal restriction information, the information providing device provides the surrounding vehicle with the temporal restriction information.

The vehicle travel control system recognizes the avoidance target lane section and executes the vehicle travel control so as to avoid the avoidance target lane section. Therefore, it is suppressed that the vehicle travels in the avoidance target lane section. This contributes to increase in confidence in the vehicle travel control system.

### BRIEF DESCRIPTION OF DRAWINGS

FIG. 1 is a conceptual diagram for explaining an outline of a vehicle travel control system according to an embodiment of the present disclosure;

FIG. 2 is a conceptual diagram for explaining an example of vehicle travel control for avoiding an avoidance target lane section in the embodiment of the present disclosure;

FIG. 3 is a conceptual diagram for explaining another example of vehicle travel control for avoiding an avoidance target lane section in the embodiment of the present disclosure;

FIG. 4 is a conceptual diagram for explaining still another example of vehicle travel control for avoiding an avoidance target lane section in the embodiment of the present disclosure;

FIG. 5 is a conceptual diagram for explaining still another example of vehicle travel control for avoiding an avoidance target lane section in the embodiment of the present disclosure;

FIG. 6 is a block diagram showing a configuration example of the vehicle travel control system according to the embodiment of the present disclosure;

FIG. 7 is a block diagram showing an example of driving environment information used in the vehicle travel control system according to the embodiment of the present disclosure;

FIG. 8 is a flow chart showing a first example of processing by the vehicle travel control system according to the embodiment of the present disclosure;

FIG. 9 is a flow chart showing a second example of processing by the vehicle travel control system according to the embodiment of the present disclosure; and

FIG. 10 is a conceptual diagram for explaining the second example of processing by the vehicle travel control system according to the embodiment of the present disclosure.

### EMBODIMENTS

Embodiments of the present disclosure will be described below with reference to the attached drawings.

### 1. Outline

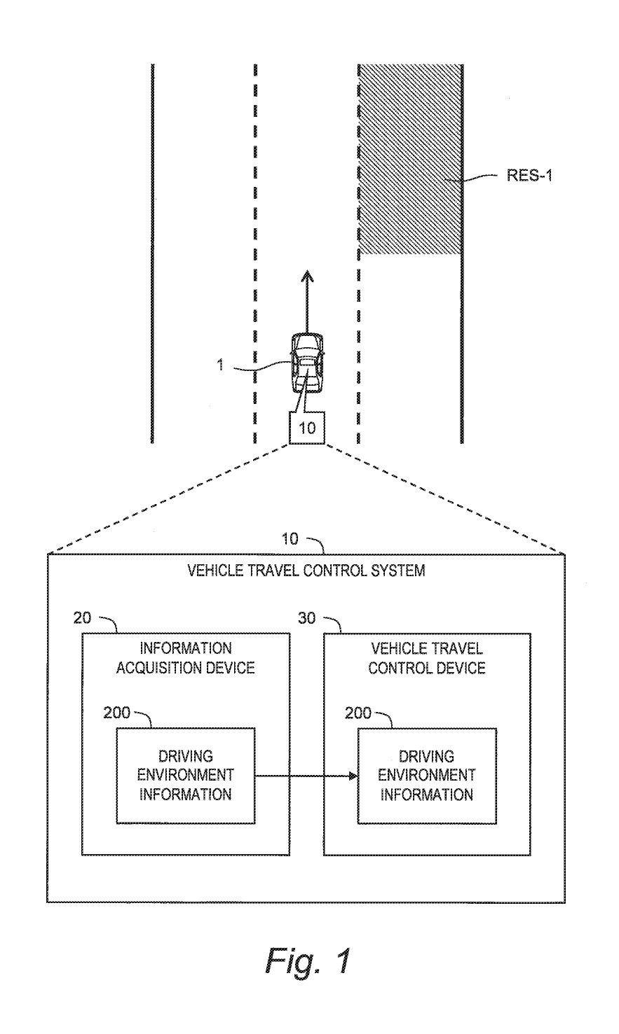

FIG. 1 is a conceptual diagram for explaining an outline of a vehicle travel control system 10 according to the present embodiment. The vehicle travel control system 10 is installed on a vehicle 1 and executes “vehicle travel control” that controls travel of the vehicle 1. More specifically, the vehicle travel control system 10 includes an information acquisition device 20 and a vehicle travel control device 30.

The information acquisition device 20 acquires information necessary for the vehicle travel control. The information necessary for the vehicle travel control is information indicating driving environment for the vehicle 1, and the information is hereinafter referred to as “driving environment information 200”.

The vehicle travel control device 30 executes the vehicle travel control based on the driving environment information 200. More specifically, based on the driving environment information 200, the vehicle travel control device 30 determines a travel lane in which the vehicle 1 travels. Then, the vehicle travel control device 30 controls the vehicle 1 to travel in the determined travel lane. Such the vehicle travel control is exemplified by automated driving control, lane tracing assist (LTA) control, and so forth.

Here, let us consider a “restricted lane section RES”. The restricted lane section RES is a lane and a section of lane in which a specific type of vehicle is prohibited from traveling. The specific type of vehicle is exemplified by a large-sized vehicle, a hazmat transport vehicle, a special vehicle, and so forth. For example, there is a case where the large-sized vehicle is prohibited from traveling in a rightmost lane of a three-lane road. In that case, the rightmost lane is the restricted lane section RES.

Especially, the restricted lane section RES in which the vehicle 1 according to the present embodiment is prohibited from traveling is hereinafter referred to as an “avoidance target lane section RES-1”. If the vehicle travel control is executed without considering the avoidance target lane section RES-1, the vehicle 1 may enter the avoidance target lane section RES-1. This causes decrease in confidence in the vehicle travel control system 10.

In view of the above, according to the present embodiment, the vehicle travel control device 30 executes the vehicle travel control in consideration of the avoidance target lane section RES-1. More specifically, the driving environment information 200 includes information indicating the restricted lane section RES and information indicating a type of the vehicle 1. Based on the driving environment information 200, the vehicle travel control device 30 recognizes the avoidance target lane section RES-1 and executes the vehicle travel control so as to avoid the avoidance target lane section RES-1. As for the vehicle travel control for avoiding the avoidance target lane section RES-1, various examples are possible as follows.

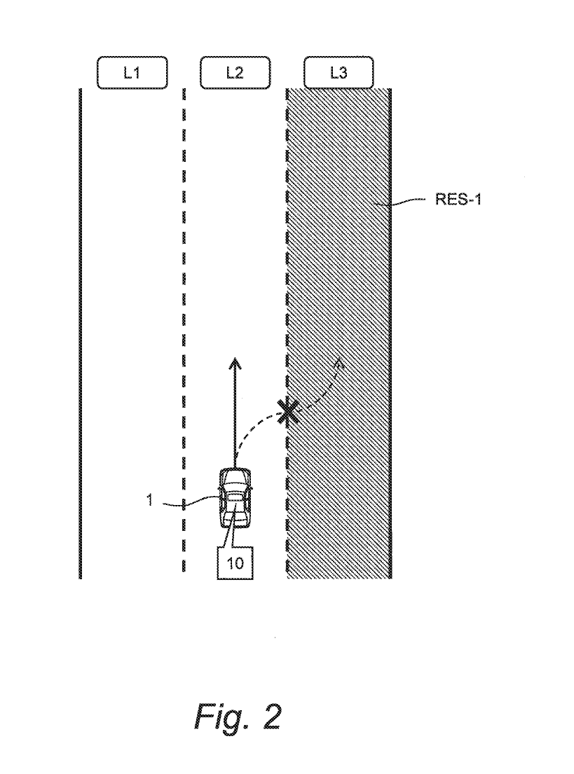

FIG. 2 is a conceptual diagram for explaining an example of the vehicle travel control for avoiding the avoidance target lane section RES-1. A road in which the vehicle 1 is traveling is a three-lane road including lanes L1 to L3. Currently, the vehicle 1 is traveling in a center lane L2. A right-side lane L3 is the avoidance target lane section RES-1. In this case, the vehicle travel control device 30 prohibits a lane change to the right-side lane L3, and selects the lane L1 or the lane L2 as the travel lane.

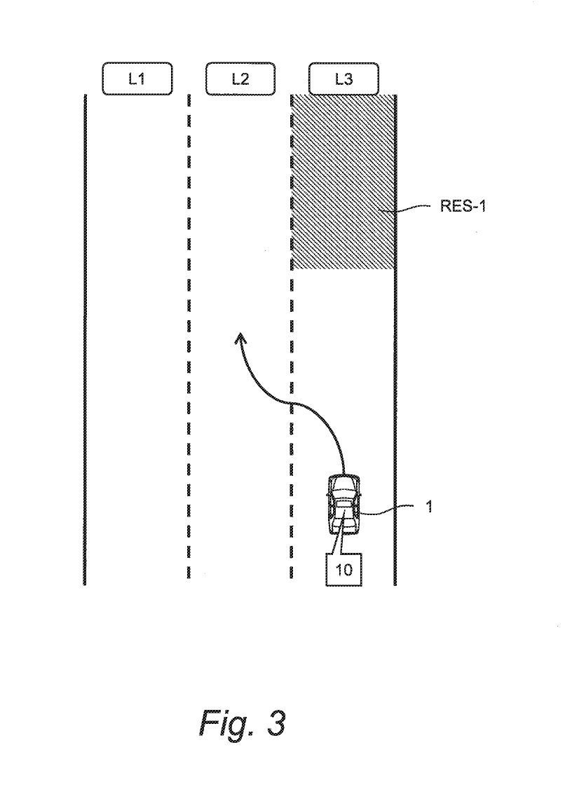

FIG. 3 is a conceptual diagram for explaining another example of the vehicle travel control for avoiding the avoidance target lane section RES-1. A road in which the vehicle 1 is traveling is a three-lane road including lanes L1 to L3. Currently, the vehicle 1 is traveling in a right-side lane L3. The lane L3 changes to the avoidance target lane section RES-1 at a position ahead of the vehicle 1. In other words, the avoidance target lane section RES-1 starts at the position ahead of the vehicle 1. In this case, the vehicle travel control device 30 selects a lane L2 as the travel lane, and makes a lane change from the lane L3 to the lane L2 before the vehicle 1 reaches the avoidance target lane section RES-1.

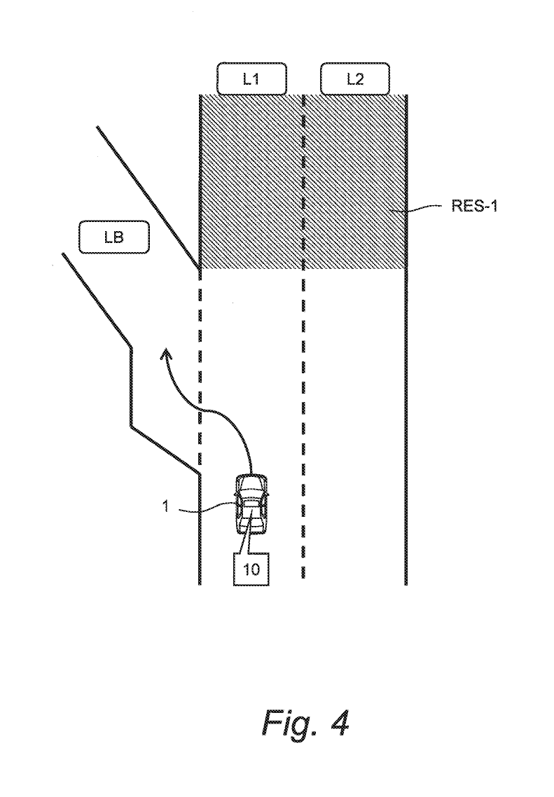

FIG. 4 is a conceptual diagram for explaining still another example of the vehicle travel control for avoiding the avoidance target lane section RES-1. A road in which the vehicle 1 is traveling is a two-lane road including lanes L1 and L2. Moreover, a branch lane LB extends from a lane branching point. Currently, the vehicle 1 is traveling in the lane L1. Both of the lanes L1 and L2 change to the avoidance target lane section RES-1 at a position beyond the lane branching point. In this case, in order to evacuate from a main line, the vehicle travel control device 30 selects the branch lane LB as the travel lane, and makes a lane change from the lane L1 to the branch lane LB.

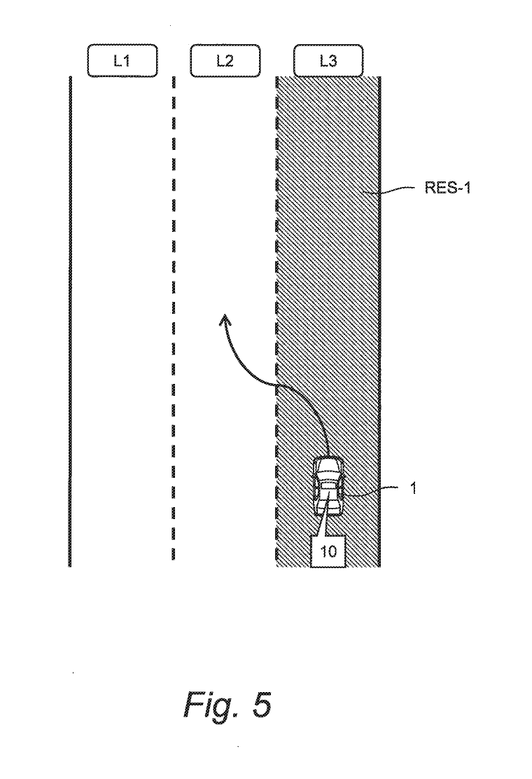

FIG. 5 is a conceptual diagram for explaining still another example of the vehicle travel control for avoiding the avoidance target lane section RES-1. When a driver turns OFF the vehicle travel control function and performs manual driving, the vehicle 1 may erroneously enter the avoidance target lane section RES-1. After that, when the driver turns ON the vehicle travel control function, the vehicle travel control device 30 immediately recognizes that the vehicle 1 is traveling in the avoidance target lane section RES-1. Then, the vehicle travel control device 30 makes a lane change in order to evacuate the vehicle 1 from the avoidance target lane section RES-1.

As described above, the vehicle travel control system 10 according to the present embodiment recognizes the avoidance target lane section RES-1 and executes the vehicle travel control so as to avoid the avoidance target lane section RES-1. Therefore, it is suppressed that the vehicle 1 travels in the avoidance target lane section RES-1. This contributes to increase in confidence in the vehicle travel control system 10.

Hereinafter, the vehicle travel control system 10 according to the present embodiment will be described in more detail.

### 2. Configuration of Vehicle Travel Control System

### 2-1. Overall Configuration Example

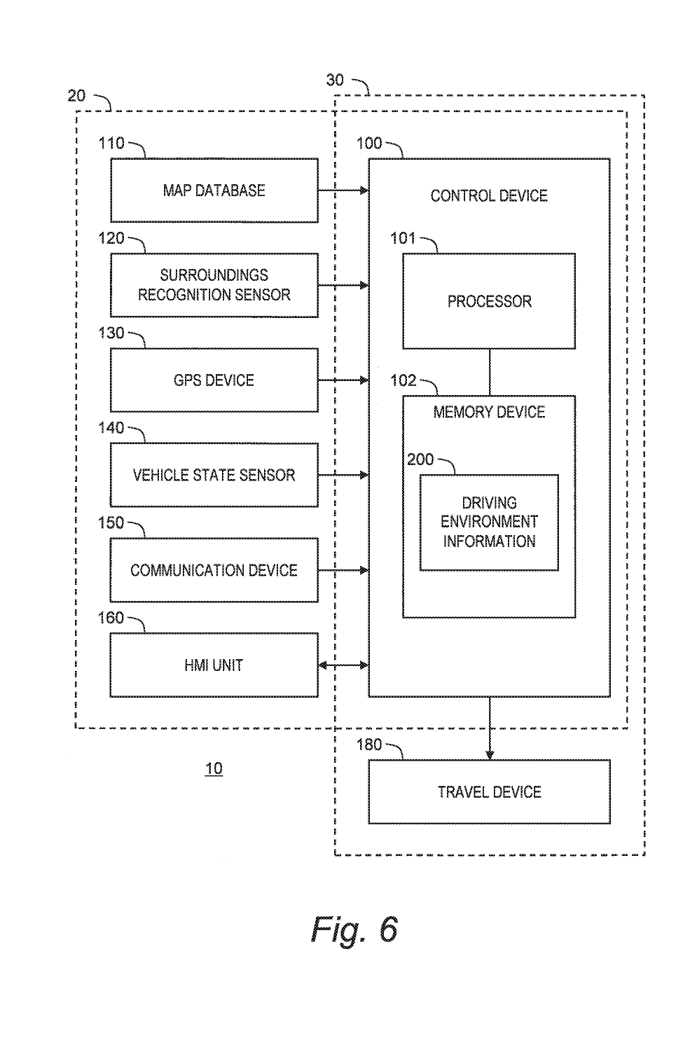

FIG. 6 is a block diagram showing a configuration example of the vehicle travel control system 10 according to the present embodiment. The vehicle travel control system 10 includes a control device (controller) 100, a map database 110, a surroundings recognition sensor 120, a GPS (Global Positioning System) device 130, a vehicle state sensor 140, a communication device 150, an HMI (Human Machine Interface) unit 160, and a travel device 180.

The control device (controller) 100 is a microcomputer provided with a processor 101 and a memory device 102. The control device 100 is also called an ECU (Electronic Control Unit). A variety of processing by the control device 100 is achieved by the processor 101 executing a control program stored in the memory device 102.

Map information is recorded in the map database 110. The map information includes lane configuration information, lane attribute information, and the like. The lane configuration information indicates a configuration (a position and a shape) of each lane on a map. The lane attribute information indicates an attribute of each lane. For example, the attribute indicates that a specific type of vehicle is prohibited from traveling in the lane. The map database 110 is achieved by a memory device.

The surroundings recognition sensor 120 recognizes a situation around the vehicle 1. The surroundings recognition sensor 120 is exemplified by a LIDAR (Laser Imaging Detection and Ranging), a radar, a camera (imaging device), and so forth. The LIDAR uses laser lights to detect a target around the vehicle 1. The radar uses radio waves to detect a target around the vehicle 1. The camera images a situation around the vehicle 1.

The GPS device 130 receives signals transmitted from a plurality of GPS satellites and calculates a position and an orientation of the vehicle 1 based on the received signals.

The vehicle state sensor 140 detects a state of the vehicle 1. For example, the vehicle state sensor 140 includes a vehicle speed sensor, a steering angle sensor, a yaw rate sensor, and so forth. The vehicle speed sensor detects a speed of the vehicle 1. The steering angle sensor detects a steering angle of the vehicle 1. The yaw rate sensor detects a yaw rate of the vehicle 1.

The communication device 150 communicates with the outside of the vehicle 1. For example, the communication device 150 performs a V2V communication (a vehicle-to-vehicle communication) with a surrounding vehicle. The communication device 150 may perform a V2I communication (a vehicle-to-infrastructure communication) with a surrounding infrastructure. In addition, the communication device 150 may communicate with a management server managing automated driving service through a communication network.

The HMI unit 160 is an interface for proving the driver with information and receiving information from the driver. More specifically, the HMI unit 160 includes an input device and an output device. The input device is exemplified by a touch panel, a switch, a microphone, and the like. The output device is exemplified by a display device, a speaker, and the like.

The travel device 180 includes a steering device, a driving device, and a braking device. The steering device turns wheels. The driving device is a power source that generates a driving force. The driving device is exemplified by an engine and an electric motor. The braking device generates a braking force.

### 2-2. Information Acquisition Device 20

The control device 100 executes “information acquisition processing” that acquires the driving environment information 200. The driving environment information 200 is stored in the memory device 102, and read out and used as appropriate.

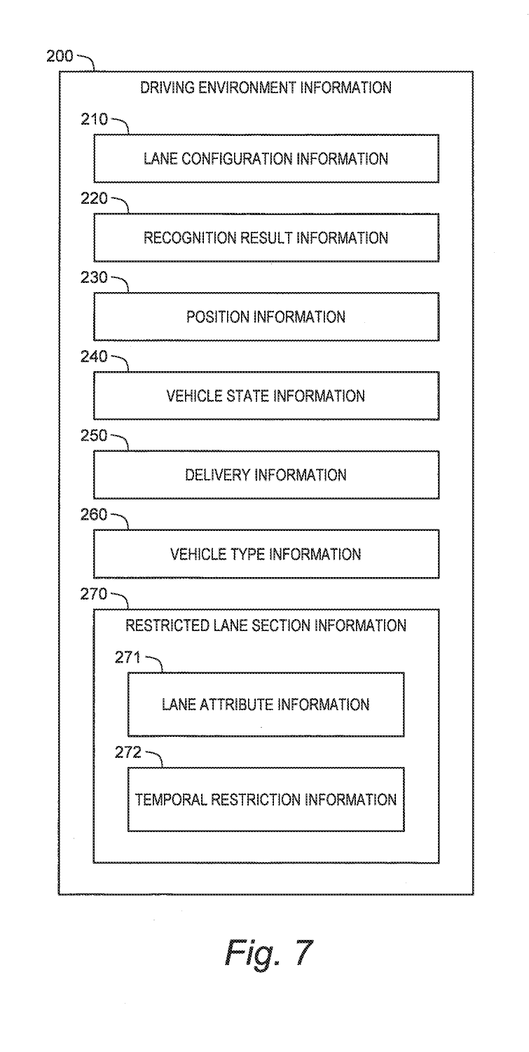

FIG. 7 shows an example of the driving environment information 200 in the present embodiment. The driving environment information 200 includes lane configuration information 210, recognition result information 220, position information 230, vehicle state information 240, delivery information 250, vehicle type information 260, and restricted lane section information 270.

The lane configuration information 210 indicates a configuration (a position and a shape) of each lane on a map. The control device 100 acquires the lane configuration information 210 of a necessary region from the map database 110.

The recognition result information 220 indicates a result of recognition by the surroundings recognition sensor 120. The recognition result information 220 includes target information regarding a target around the vehicle 1. The target around the vehicle 1 is exemplified by a surrounding vehicle, a white line, a traffic sign, a signage, and so forth. The target information includes a relative position, a relative velocity, and the like of the detected target as seen from the vehicle 1.

The position information 230 indicates a position of the vehicle 1. The position information 230 has an accuracy with which the travel lane in which the vehicle 1 travels is identifiable. The position information 230 may further include information indicating the travel lane. For example, the control device 100 acquires the position information 230 from the GPS device 130. Moreover, the control device 100 may recognize the position of the vehicle 1 with a higher degree of accuracy by matching the lane configuration information 210 (the lane configuration around the vehicle 1) with the recognition result information 220 (the result of recognition of the white line).

The vehicle state information 240 indicates the state of the vehicle 1. For example, the vehicle state information 240 indicates the vehicle speed, an acceleration, a deceleration, the steering angle, the yaw rate, and so forth. The control device 100 acquires the vehicle state information 240 based on a result of detection by the vehicle state sensor 140.

The delivery information 250 is information acquired through the communication device 150. For example, the delivery information 250 includes road traffic information (road work zone information, accident information, traffic restriction information, and the like) delivered from the infrastructure. The control device 100 acquires the delivery information 250 by using the communication device 150 to communicate with the outside of the vehicle 1.

The vehicle type information 260 is information indicating the type of the vehicle 1. The type of the vehicle 1 is exemplified by a standard vehicle, a small-sized vehicle, a mid-sized vehicle, a large-sized vehicle, a hazmat transport vehicle, a special vehicle, and so forth. The vehicle type information 260 may further include information of a length, a width, and a height of the vehicle 1. Foe example, the vehicle type information 260 in input by the driver through the HMI unit 160. As another example, the vehicle type information 260 is beforehand stored in the memory device 102 of the control device 100 during a manufacturing process.

The restricted lane section information 270 indicates a position of the restricted lane section RES. The restricted lane section information 270 includes at least one of lane attribute information 271 and temporal restriction information 272.

The lane attribute information 271 indicates a position of the restricted lane section RES that steadily exists. The restricted lane section RES existing steadily is predetermined. Typically, the lane attribute information 271 is included in the map database 110. The control device 100 acquires the lane attribute information 271 of a necessary region from the map database 110.

As another example, the restricted lane section RES existing steadily is indicated by a traffic sign. In that case, the control device 100 recognizes the restricted lane section RES and acquires the lane attribute information 271 based on the recognition result information 220 (specifically, the result of recognition of the traffic sign).

As still another example, the lane attribute information 271 may be delivered by an information providing system outside the vehicle 1. That is, the delivery information 250 may include the lane attribute information 271. In that case, the control device 100 acquires the lane attribute information 271 from the information providing system through the communication device 150.

On the other hand, the temporal restriction information 272 indicates a position of the restricted lane section RES that temporarily occurs. For example, the restricted lane section RES can temporarily occur due to an unexpected event such as road work and accident. Such the temporal restriction information 272 is not included in the map database 110.

Instead, the temporal restricted lane section RES is indicated by a roadside signage, for example. In that case, the control device 100 recognizes the temporal restricted lane section RES and acquires the temporal restriction information 272 based on the recognition result information 220 (specifically, the result of recognition of the signage).

As another example, the temporal restriction information 272 may be provided from an information providing system or a surrounding vehicle outside the vehicle 1. That is, the delivery information 250 may include the temporal restriction information 272. In that case, the control device 100 acquires the temporal restriction information 272 from the information providing system or the surrounding vehicle through the communication device 150.

It can be said that the control device 100, the map database 110, the surroundings recognition sensor 120, the GPS device 130, the vehicle state sensor 140, the communication device 150, and the HMI unit 160 constitute the “information acquisition device 20” shown in FIG. 1.

### 2-3. Vehicle Travel Control Device 30

The control device 100 executes the vehicle travel control based on the driving environment information 200. More specifically, the control device 100 determines the travel lane and a target path (target trajectory) based on the driving environment information 200. Then, the control device 100 performs the vehicle travel control based on the driving environment information 200 such that the vehicle 1 travels in the travel lane with following the target path. The vehicle travel control includes acceleration control, deceleration control, and steering control. The control device 100 executes the acceleration control, the deceleration control, and the steering control by appropriately actuating the travel device 180 (i.e. the driving device, the braking device, and the steering device).

It can be said that the control device 100 and the travel device 180 constitute the “vehicle travel control device 30” shown in FIG. 1.

### 3. Processing by Vehicle Travel Control Device

### 3-1. First Example

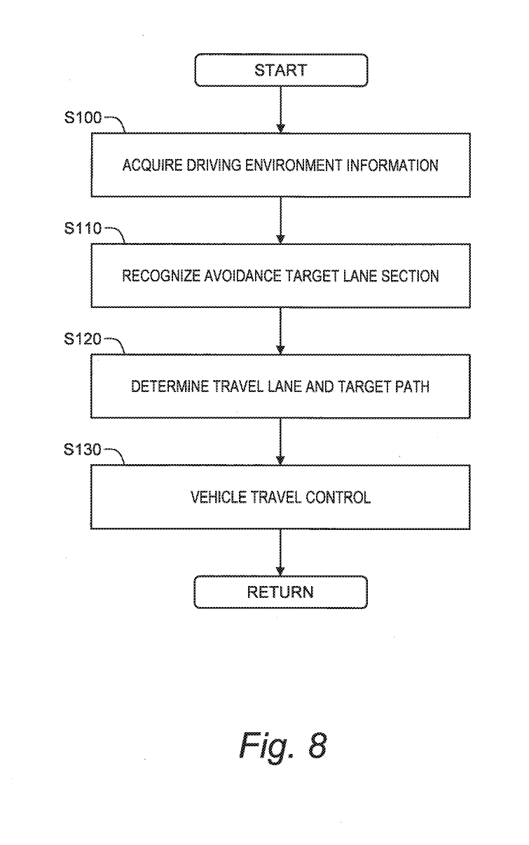

FIG. 8 is a flow chart showing a first example of processing by the vehicle travel control system 10 according to the present embodiment. The processing shown in FIG. 8 is repeatedly executed every certain cycle.

In Step S100, the information acquisition device 20 acquires the driving environment information 200. The vehicle travel control device 30 receives the driving environment information 200 from the information acquisition device 20.

In subsequent Step S110, the vehicle travel control device 30 recognizes the avoidance target lane section RES-1 in which the vehicle 1 is prohibited from traveling, based on the vehicle type information 260 and the restricted lane section information 270.

In subsequent Step S120, the vehicle travel control device 30 determines the travel lane and the target path. More specifically, based on the lane configuration information 210 and the position information 230, the vehicle travel control device 30 determines the travel lane such that the vehicle 1 avoids the avoidance target lane section RES-1 (see FIGS. 2 to 5).

The target path is a lane-level trajectory of the vehicle 1. The target path includes a trajectory of the vehicle 1 within a single lane. In addition, the target path includes trajectories of the vehicle 1 for a lane change and overtaking. As for a method of calculating the target path, various examples have been proposed. In the present embodiment, the method of calculating thereof is not limited in particular.

In subsequent Step S130, the vehicle travel control device 30 executes the vehicle travel control based on the driving environment information 200 such that the vehicle 1 travels in the travel lane with following the target path. As described above, the travel lane is determined so as to avoid the avoidance target lane section RES-1. Accordingly, the vehicle travel control device 30 executes the vehicle travel control so as to avoid the avoidance target lane section RES-1 (see FIGS. 2 to 5).

It should be noted that when making a lane change in order to avoid the avoidance target lane section RES-1 (see FIGS. 3 to 5), the vehicle travel control device 30 may use the HMI unit 160 to notify the driver of a fact that “an avoiding action is to be performed”.

### 3-2. Second Example

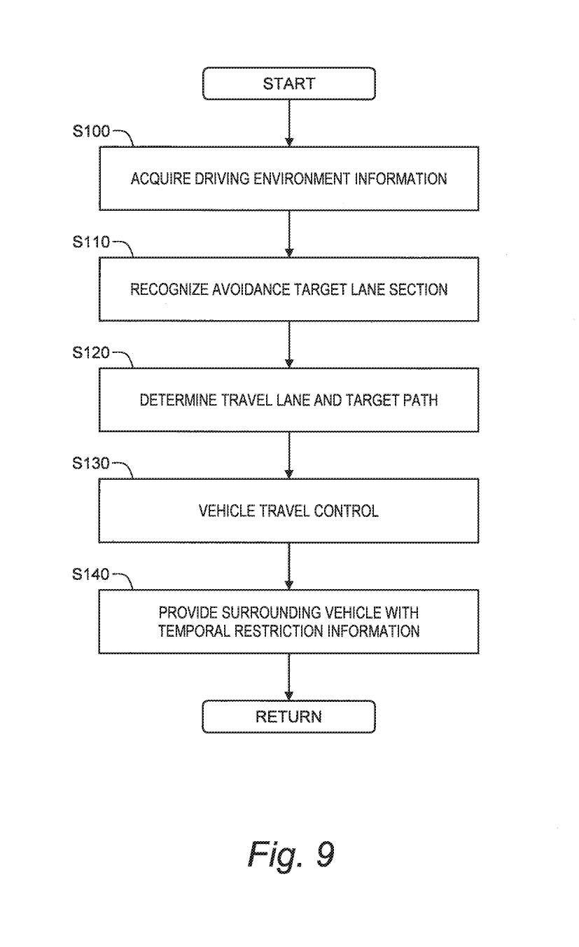

FIG. 9 is a flow chart showing a second example of processing by the vehicle travel control system 10 according to the present embodiment. An overlapping description with the first example will be omitted as appropriate. In the second example, Step S140 is added as compared with the first example.

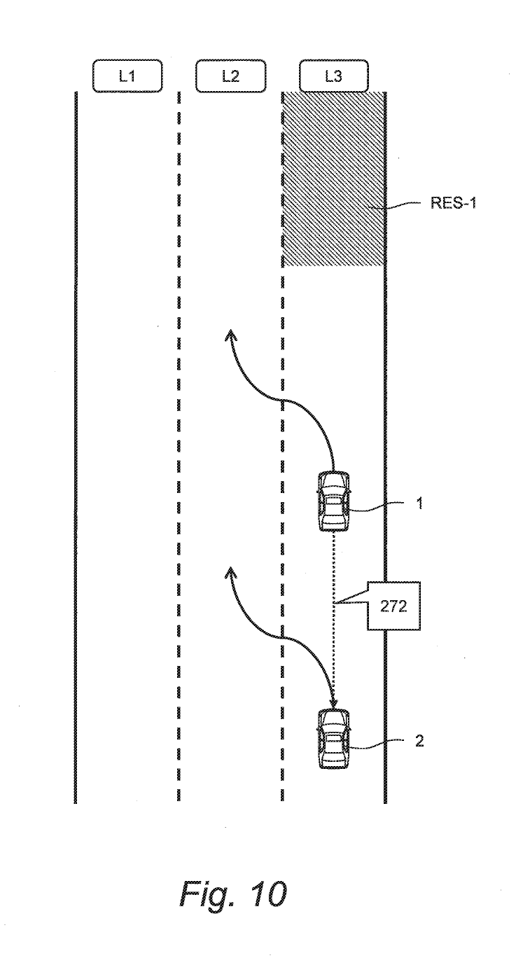

FIG. 10 is a conceptual diagram for explaining Step S140. There is a surrounding vehicle 2 around the vehicle 1. In Step S140, the control device 100 provides the surrounding vehicle 2 with the temporal restriction information 272 through the communication device 150. It can be said that the control device 100 and the communication device 150 constitute an “information providing device” that communicates with the surrounding vehicle 2 to provide the surrounding vehicle 2 with the temporal restriction information 272.

A driver of the surrounding vehicle 2 is able to early recognize the avoidance target lane section RES-1 by referring to the temporal restriction information 272 provided from the vehicle 1. When a vehicle type of the surrounding vehicle 2 is the same as the vehicle 1, the driver of the surrounding vehicle 2 is able to early start a driving operation for avoiding the avoidance target lane section RES-1.

It is further useful when the vehicle travel control system 10 according to the present embodiment is installed also in the surrounding vehicle 2. In that case, the vehicle travel control system 10 installed on the surrounding vehicle 2 acquires the temporal restriction information 272 from the vehicle 1. When the vehicle type of the surrounding vehicle 2 is the same as the vehicle 1, the vehicle travel control system 10 is able to early start the vehicle travel control for avoiding the avoidance target lane section RES-1.

What is claimed is:

1. A vehicle travel control system installed on a vehicle and comprising:
an information acquisition device configured to acquire driving environment information indicating driving environment for the vehicle; and
a vehicle travel control device configured to execute vehicle travel control that determines a travel lane and controls the vehicle to travel in the travel lane based on the driving environment information,
wherein a restricted lane section is a lane and a section of lane in which a specific type of vehicle is prohibited from traveling,
wherein the driving environment information includes:
lane configuration information indicating a configuration of each lane;
position information indicating a position of the vehicle with an accuracy with which the travel lane is identifiable;
vehicle type information indicating a type of the vehicle; and
restricted lane section information indicating a position of the restricted lane section,
wherein the vehicle travel control device is further configured to:
recognize, based on the vehicle type information and the restricted lane section information, an avoidance target lane section being the restricted lane section in which the vehicle is prohibited from traveling; and
execute the vehicle travel control so as to avoid the avoidance target lane section based on the lane configuration information and the position information.

2. The vehicle travel control system according to claim 1,
wherein the restricted lane section information includes at least one of:
lane attribute information indicating a position of the restricted lane section that steadily exists; and
temporal restriction information indicating a position of the restricted lane section that temporarily occurs.

3. The vehicle travel control system according to claim 2, further comprising an information providing device configured to communicate with a surrounding vehicle,
wherein when the restricted lane section information includes the temporal restriction information, the information providing device provides the surrounding vehicle with the temporal restriction information.
